(19) United States
(12) Patent Application Publication
(10) Pub. No.: US 2024/0232513 A1
(43) Pub. Date: Jul. 11, 2024

(54) INFORMATION PROCESSING APPARATUS, INFORMATION PROCESSING METHOD, AND STORAGE MEDIUM

(71) Applicant: KABUSHIKI KAISHA TOSHIBA, Tokyo (JP)

(72) Inventors: Tomohiro Yamasaki, Tokyo (JP); Kazunori Imoto, Kawasaki Kanagawa (JP)

(73) Assignee: KABUSHIKI KAISHA TOSHIBA, Tokyo (JP)

(21) Appl. No.: 18/458,246

(22) Filed: Aug. 30, 2023

(30) Foreign Application Priority Data
Jan. 11, 2023 (JP) 2023-002503

(51) Int. Cl. G06F 40/166; G06F 40/117; G06F 40/30

(52) U.S. Cl. CPC G06F 40/166; G06F 40/117; G06F 40/30

(57) ABSTRACT

According to one embodiment, an information processing apparatus includes a processor including a hardware. The processor performs augmentation on a token string included in acquired document data so as to maintain an arrangement of an original token string to generate a plurality of augmented token strings. The processor estimates a tag to be appended to each of the augmented token strings. The processor determines a tag to be appended to the token string based on the tag estimated for each of the augmented token strings.

### CROSS-REFERENCE TO RELATED APPLICATIONS

This application is based upon and claims the benefit of priority from the Japanese Patent Application No. 2023-002503, filed Jan. 11, 2023, the entire contents of which are incorporated herein by reference.

### FIELD

Embodiments described herein relate generally to an information processing apparatus, an information processing method, and a storage medium.

### BACKGROUND

There is an attempt to extract expressions related to troubles from documents created in various kinds of business such as infrastructure business. Techniques such as sequence labeling can be used to extract expressions related to such troubles. In order to extract expressions using sequence labeling or the like, training of an estimation model of tags representing the expressions is required. However, documents created in infrastructure business or the like are difficult to understand without specialized knowledge, and thus it is difficult to prepare a large amount of high-quality training data.

Furthermore, in extracting an expression from a document, it is necessary to handle discrete values such as characters and words, unlike extracting images. Therefore, it is difficult to realize data augmentation, which is a general technique in extracting an image. There is also a technique called embedding for converting a character or a word into continuous values, but simple data augmentation such as enlargement, reduction, rotation, or trimming used for image extraction cannot be applied to such continuous values in which a character or a word is embedded. As a data augmentation method for a document, a method of replacing a specific word with a synonym, a method of randomly inserting a word in a sentence, a method of randomly deleting a word from a sentence, or a method of randomly exchanging words in a sentence are also known. However, in the method of randomly inserting a word into a sentence, the method of randomly deleting a word from a sentence, or the method of randomly exchanging words in a sentence, the obtained data may cause noise. There is a possibility that the estimation by the estimation model of tags trained with training data including many noises is not stable. In addition, for the method of replacing a specific word with a synonym, it is difficult to prepare an appropriate synonym in the first place.

### BRIEF DESCRIPTION OF THE DRAWINGS

FIG. 1 is a block diagram illustrating a configuration related to tagging of an information processing apparatus according to an embodiment.

FIG. 2 is a flowchart illustrating an operation of tagging by the information processing apparatus.

FIG. 3 is a diagram for describing augmentation of a token string.

FIG. 4 is a diagram for describing voting.

FIG. 5 is a block diagram illustrating a configuration related to training of a tag estimation model of the information processing apparatus according to the embodiment.

FIG. 6 is a flowchart illustrating an operation of training of the tag estimation model by the information processing apparatus.

FIG. 7 is a diagram for describing augmentation of a tag.

FIG. 8 is a diagram for describing augmentation of a token string in a modification.

FIG. 9 is a diagram for describing voting in a modification.

FIG. 10 is a diagram illustrating an example of a hardware configuration of the information processing apparatus.

### DETAILED DESCRIPTION

In general, according to one embodiment, an information processing apparatus includes a processor including a hardware. The processor performs augmentation on a token string included in acquired document data so as to maintain an arrangement of an original token string to generate a plurality of augmented token strings. The processor estimates a tag to be appended to each of the augmented token strings. The processor determines a tag to be appended to the token string based on the tag estimated for each of the augmented token strings.

Hereinafter, embodiments will be described with reference to the drawings. The information processing apparatus according to an embodiment divides a sentence included in document data into words (tokens) and appends a tag to a token constituting a unique expression. As a tag of a unique expression, a personal name tag “PSN”, a date tag “DAT”, a time tag “TIM”, and the like are known. It is common that a first token constituting a unique expression is given “B-”, a subsequent token is given “I-”, and a token that is not a unique expression is given “O”. An information processing apparatus 100 converts the token into an embedding vector (numerical string) by a trained deep learning model such as word2Vec and BERT, for example, and appends a tag by using a tag estimation model. The tagged document can be used as training data for various types of training.

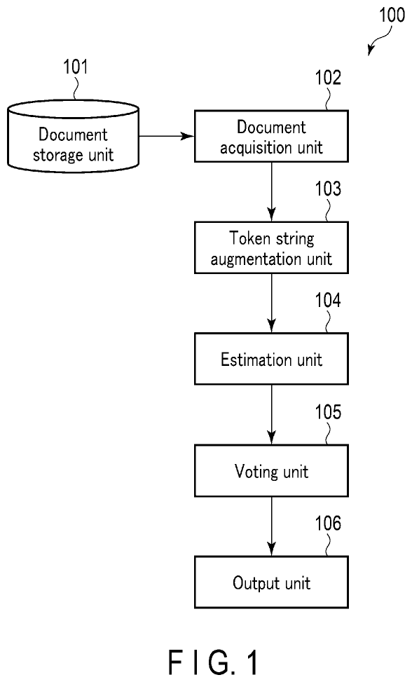

FIG. 1 is a block diagram illustrating a configuration related to tagging of an information processing apparatus according to an embodiment. The information processing apparatus 100 is a computer including a document storage unit 101, a document acquisition unit 102, a token string augmentation unit 103, an estimation unit 104, a voting unit 105, and an output unit 106.

The document storage unit 101 stores large volumes of document data. The document data may be, for example, data generated from a document created in an infrastructure business. The document storage unit 101 may store a document as a corpus. The corpus is a database in which documents are structured and recorded as to be referred to by a computer. Here, the document storage unit 101 is not necessarily provided in the information processing apparatus 100, and may be provided outside the information processing apparatus 100.

The document acquisition unit 102 acquires document data from the document storage unit 101 in units of token strings.

The token string augmentation unit 103 performs augmentation on a token string in the document data acquired by the document acquisition unit 102 so as to maintain an arrangement of an original token string, thereby generating a plurality of augmented token strings. As an example, the token string augmentation unit 103 generates augmented token strings by looping a token string while shifting the start position. At this time, the token string augmentation unit 103 may mask the token with an appropriate probability set in advance (replace with [MASK]).

The estimation unit 104 estimates a tag to be appended to each token of the augmented token strings by inputting the augmented token strings to the tag estimation model. The tag estimation model appends a tag to a token by, for example, a sequence labeling method. Specifically, the tag estimation model performs vector embedding to the token by word2Vec, BERT, and the like, and estimates a tag to be appended to each of the embedded vectorized tokens.

The voting unit 105 determines a tag to be finally appended to the token of the original document by voting based on the estimation result of the tag for each token in the augmented token string. Specifically, the voting unit 105 determines a tag estimated to be appended most to the same token as a tag to be finally appended to the tag.

The output unit 106 outputs the tagged document data. The tagged document data is data in which a tag is appended to the original document. The output destination of the tagged document data is, for example, the document storage unit 101. The output unit 106 may output the tagged document data to a document storage unit outside the information processing apparatus 100. The tagged document data stored in the document storage unit can be used as training data for training of an estimation model of a tag for extracting an expression related to a trouble from a document, for example. In addition, the tagged document data stored in the document storage unit can also be used for training of the tag estimation model of the estimation unit 104.

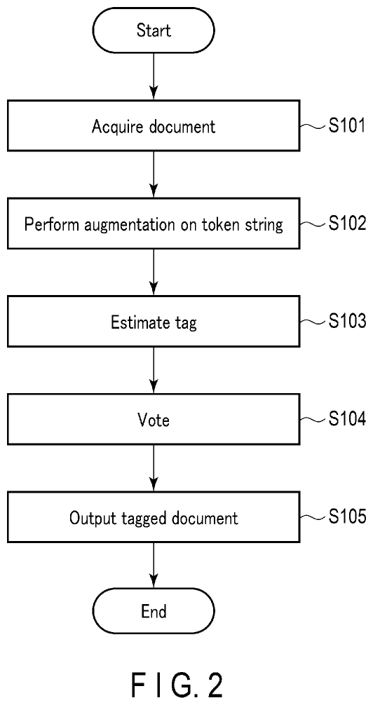

Next, an operation of the information processing apparatus 100 will be described. FIG. 2 is a flowchart illustrating operation of tagging by the information processing apparatus 100. In the following description, it is assumed that the tag estimation model is a trained model. Training of the tag estimation model will be described in detail later.

In step S101, the document acquisition unit 102 acquires document data from the document storage unit 101. Unlike at the time of training to be described later, the document data acquired in step S101 is document data to which no tag is appended.

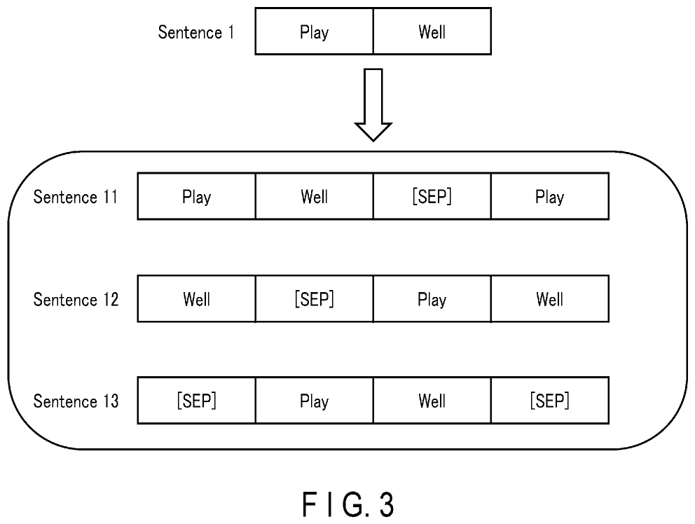

In step S102, the token string augmentation unit 103 performs augmentation on a token string in the acquired document data. The augmentation of a token string will be specifically described below with reference to FIG. 3. FIG. 3 is a diagram illustrating a method of generating an augmented token string for a sentence 1 which is “play”, “well”.

First, the token string augmentation unit 103 obtains the number of tokens T_S of each sentence S of the document data. Subsequently, the token string augmentation unit 103 obtains the number of tokens f(T_S) of the augmented token string generated by looping the token string using an appropriate function f. Usually, the string length of each token string is not uniform; however, it is desirable that the string length of each token string be uniform for tag estimation. Although there is also a technique of using padding to align the string length of the token string, in the embodiment, the string length of the token string is aligned by looping the token string. Further, in the embodiment, augmented token strings are generated from one token string by changing the shift amount of the token string when the token string is looped. The number of f(T_S) may be any integer greater than T_S. For example, f(T_S) can be obtained by calculation of αT_S+β (α and β are appropriate coefficients of 1 or more), calculation of a minimum power of 2 exceeding T_S, or the like.

For example, the sentence 1 of “play”, “well” shown in FIG. 3 is composed of two tokens. Therefore, T_S of the sentence 1 is 2. For such T_S, the token string augmentation unit 103 calculates, for example, a minimum power value of 2 exceeding T_S as f(T_S). In this example, f(T_S) is 4.

Next, the token string augmentation unit 103 sets a shift amount of the token string. For example, in a case where K augmented token strings are generated by performing augmentation on the token string, most simply, the token string augmentation unit 103 sets the shift amount to be shifted by 1, such as 0 token, 1 token, . . . , and K-1 token. For example, in a case where three augmented token strings are generated from the sentence 1 illustrated in FIG. 3, the token string augmentation unit 103 sets the shift amounts to 0 token, 1 token, and 2 tokens.

Next, the token string augmentation unit 103 generates augmented token strings by looping the token string with a start position shifted according to the shift amount so that the number of tokens becomes f(T_S). Here, the token string augmentation unit 103 shifts the token string in which the separator [SEP] is inserted at the end of the original token string so that a set of the original token string can be identified.

For example, in FIG. 3, the token string augmentation unit 103 generates a sentence 11 in which a token string in which the start position of the sentence 1 is shifted by 0 token is looped so that the number of tokens becomes 4, a sentence 12 in which a token string in which the start position of the sentence 1 is shifted by 1 token is looped so that the number of tokens becomes 4, and a sentence 13 in which a token string in which the start position of the sentence 1 is shifted by 2 tokens is looped so that the number of tokens becomes 4.

A sentence 11 is generated by looping “play”, “well”, “[SEP]” in which the token string “play”, “well”, “[SEP]” is shifted by 0 token so that the number of tokens is 4 tokens. That is, the sentence 11 is configured by adding one token “play” after looping after “[SEP]”.

A sentence 12 is generated by looping “well”, “[SEP]” in which the token string “play”, “well”, “[SEP]” is shifted by 1 token so that the number of tokens is 4 tokens. That is, the sentence 12 is configured by adding the two tokens “play” and “well” after looping after “[SEP]”.

A sentence 13 is generated by looping “[SEP]” in which the token string “play”, “well”, “[SEP]” is shifted by 2 tokens so that the number of tokens is 4 tokens. That is, the sentence 13 is configured by adding three tokens “play”, “well”, “[SEP]” after looping after the “[SEP]”.

Here, the sentences 11 to 13 are simply generated by looping the token, but may be generated by masking the token with an appropriate probability set in advance (replacing with [MASK]) as described above.

In addition, the method of calculating f(T_S) for generating the augmented token string is not limited to the above-described method. For example, by using the maximum value max (T_S) of T_S, f(T_S) may be obtained by calculation of αmax (T_S)+β, calculation of a minimum power of 2 exceeding max (T_S), or the like.

In addition, if the amount of shift is too small when f(T_S) is considerably larger than K, the augmented token string generated thereby is biased to one with a relatively small amount of shift. In order to suppress such bias, the shift amount may be set by (f(T_S)/K)×n (n is an integer from 0 to K-1). However, since the shift amount is an integer value, when a fraction after the decimal point occurs as a result of the calculation of the shift amount, the fraction after the decimal point is rounded off. In addition, in order to suppress the bias, the shift amount may be set from K random number values.

Here, the description returns to FIG. 2. In step S103, the estimation unit 104 inputs the augmented token strings to the tag estimation model and estimates a tag to be appended to each token of the augmented token strings. In sequence labeling, a range starting with B and followed by I is a range of a tag of the same unique expression.

In step S104, the voting unit 105 performs voting for determining a tag to be finally appended to each token in the augmented token strings. In the embodiment, K augmented token strings are generated from one token string, and the original token is looped in each augmented token string. In this case, since the original token may appear a plurality of times in each augmented token string, the voting unit 105 performs voting using them as different tokens. Specifically, the voting unit 105 counts as which tag is estimated for the original token.

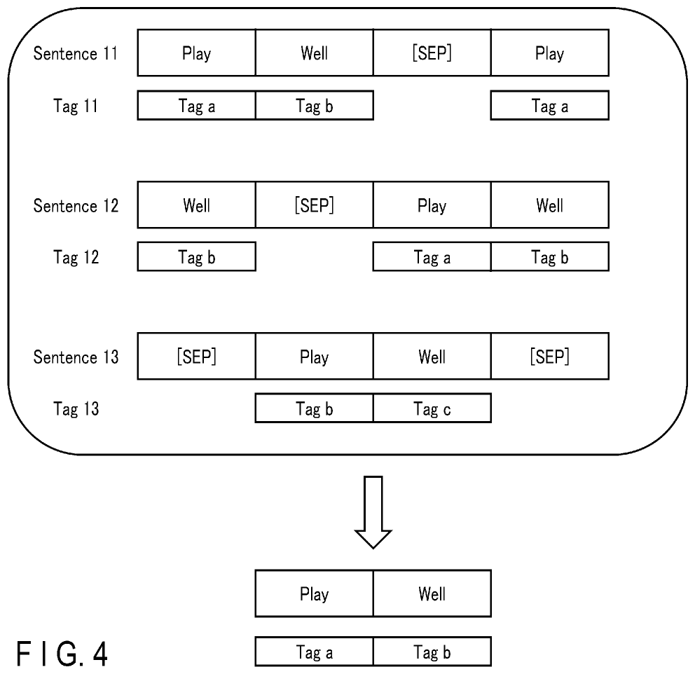

FIG. 4 is a diagram for describing voting. As a result of the estimation by the tag estimation model, it is assumed that tags indicated by a tag 11 should be appended to each token of the sentence 11, tags indicated by a tag 12 should be appended to each token of the sentence 12, and tags indicated by a tag 13 should be appended to each token of the sentence 13.

The voting unit 105 counts tags estimated for the original token. In the example of FIG. 4, for the original token “play”, three “tag a” and one “tag b” are estimated as a tag to be appended. At this time, the voting unit 105 determines the “tag a” with the most votes as a tag for the original token “play”. Similarly, for the original token “well”, three “tag b” and one “tag c” are estimated as a tag to be appended. At this time, the voting unit 105 determines the “tag b” with the most votes as a tag for the original token “well”.

In the example of FIG. 4, the tag to be finally appended is determined by simple majority decision. On the other hand, the tag may be appended only when the ratio of the tag having the maximum number of votes for each token to the total number of votes exceeds a predetermined threshold. For example, in the case of majority voting, the number of votes for multiple tags may be the same. In this case, the tag may not be appended when the ratio of the maximum number of votes to the total number of votes does not exceed the threshold. The threshold may be changed according to the appearance frequency of a tag. As another voting, a weight of a vote may be changed for each tag.

Here, the description returns to FIG. 2. In step S105, the output unit 106 outputs tagged document data in which tags are appended to the original tokens. Thereafter, the process of FIG. 2 ends. The output destination of the tagged document data may be a display device or a storage that stores training data used for training of an arbitrary model.

As described above, in the embodiment, the augmented token string is generated by looping the token string input to the tag estimation model so that the predetermined number of tokens are obtained. Furthermore, a plurality of different augmented token strings are generated by changing the shift amount of the token string at the time of looping. As described above, in the embodiment, the data augmentation of the token string can be performed by a simple method. In addition, since the augmented token string is generated by shifting the start position of the original token string, the information of the original token string is held as it is. Therefore, the augmented token string generated by the method of the embodiment is less likely to be noise. Furthermore, by looping, a situation in which a line feed is performed in the middle of a line can be reproduced in a pseudo manner in one augmented token string. Then, at the time of estimating the tag, the range of the tag to be finally appended is determined by voting on the result using the plurality of augmented token strings. Therefore, the estimation result of the tag is easily stabilized. As a result, the performance and robustness of the tag estimation model can be improved.

Here, in the embodiment, the token string is looped such that the number of tokens of the augmented token string becomes f(T_S). On the other hand, the augmented token string may be generated by looping the token string a predetermined number of times.

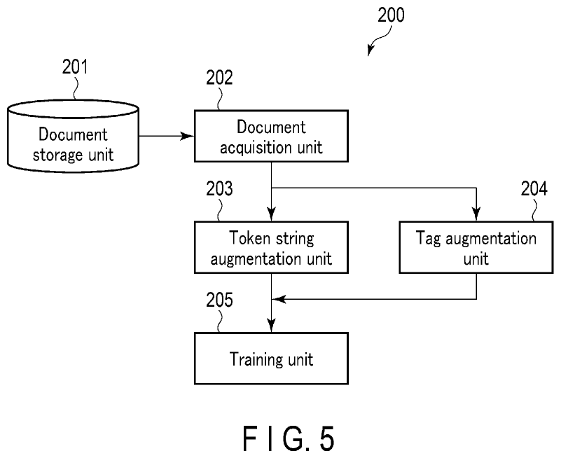

Next, training of the tag estimation model will be described. FIG. 5 is a block diagram illustrating a configuration related to training of a tag estimation model of the information processing apparatus according to the embodiment. The information processing apparatus 200 is a computer including a document storage unit 201, a document acquisition unit 202, a token string augmentation unit 203, a tag augmentation unit 204, and a training unit 205. Each element of the information processing apparatus 200 may be provided in an information processing apparatus different from the information processing apparatus 100, or may be provided in the same information processing apparatus.

The document storage unit 201 stores large volumes of tagged document data. The tagged document data is document data in which a tag is appended to each token. The tagged document data may be provided by a user, or may be document data to which a tag is appended as a result of the processing of FIG. 2 described above. The document storage unit 201 is not necessarily provided in the information processing apparatus 200, and may be provided outside the information processing apparatus 200.

The document acquisition unit 202 acquires the tagged document data in units of token strings from the document storage unit 201.

The token string augmentation unit 203 generates a plurality of augmented token strings by performing augmentation on the token string in the document data acquired by the document acquisition unit 202. As an example, the token string augmentation unit 203 generates a plurality of augmented token strings by looping the token string while shifting the start position similarly to the token string augmentation unit 103.

The tag augmentation unit 204 performs augmentation on a tag in the document data acquired by the document acquisition unit 202. As an example, the tag augmentation unit 204 performs augmentation on the tag by looping the tag similarly to the token string augmentation unit 203.

The training unit 205 performs training of the tag estimation model using the augmented token string with augmented tags as training data. As an example, the training unit 205 performs tag estimation by inputting document data without tag to the tag estimation model, and updates the weight of the network of the tag estimation model or the like so as to minimize an error between the tag estimation result and the tag appended to the augmented token string.

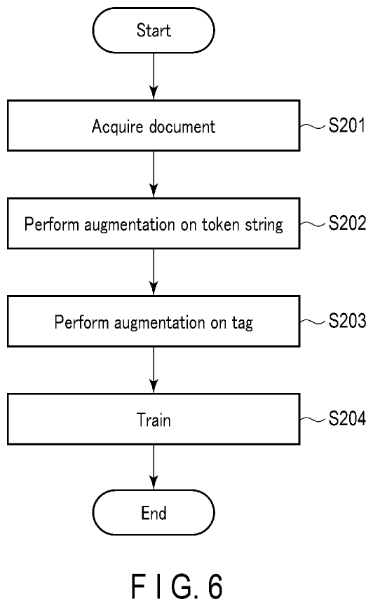

Next, an operation of the information processing apparatus 200 will be described. FIG. 6 is a flowchart illustrating an operation of training of the tag estimation model by the information processing apparatus 200.

In step S201, the document acquisition unit 202 acquires the tagged document data.

In step S202, the token string augmentation unit 203 performs augmentation on the token string in the acquired tagged document data. The augmentation of the token string may be performed similarly to that described in step S102. Note that the number K of augmented token strings to be generated at the time of training and at the time of estimation may be the same or different.

In step S203, the tag augmentation unit 204 performs augmentation on the tag appended to the tagged document data. The range of the augmented tag is the same as the range of the augmented token string. The tag augmentation unit 204 obtains a range of the tag appended to the original token among the tokens generated by looping the token string, and appends the corresponding tag to the looped token string as well. Here, since the correct answer of general sequence labeling is expressed in the BIO format, the range of the tag always starts with B. However, in a case where the token string is looped while being shifted, there is a possibility that the range of the tag is divided and starts from I in the middle. The tag augmentation unit 204 replaces the token string starting from I in the augmented token strings with the token string starting from B.

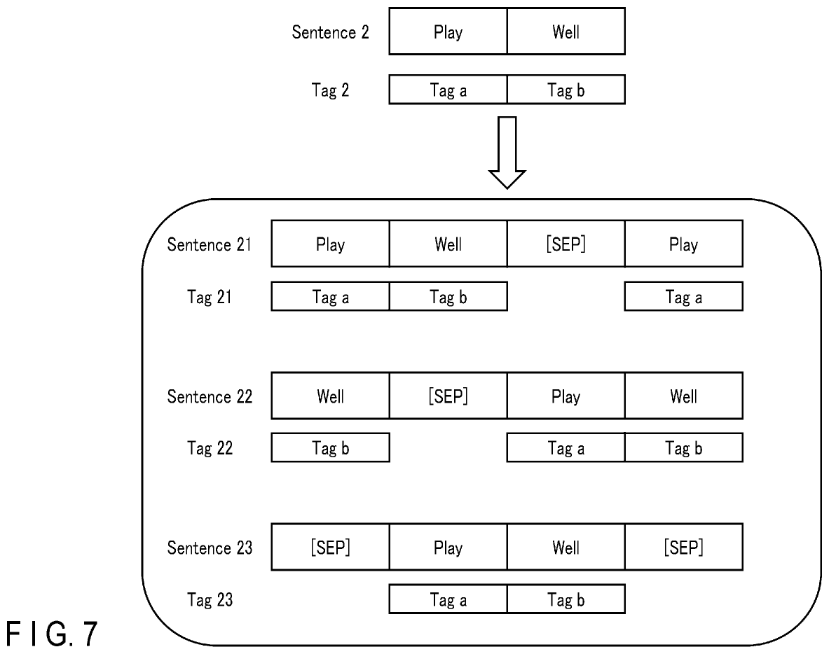

The tag augmentation will be specifically described below with reference to FIG. 7. FIG. 7 is a diagram illustrating an augmentation method of a tag with respect to a tagged token string in which a tag 2 including “tag a” and “tag b” is appended to a sentence 2, “play”, “well”. In FIG. 7, “tag a” is appended to “play”, and “tag b” is appended to “well”.

The augmented token strings generated by the token string augmentation unit 203 are a sentence 21 which is the same as the sentence 11, a sentence 22 which is the same as the sentence 12, and a sentence 23 which is the same as the sentence 13. The tag augmentation unit 204 loops the tag while shifting the tag by the same shift amount as the augmented token string. As a result, “tag a” is given to each “play” of the sentence 21, and “tag b” is given to each “well” of the sentence 21. Similarly, “tag a” is given to each “play” of the sentence 22, and “tag b” is given to each “well” of the sentence 22. Similarly, “tag a” is given to each “play” of the sentence 23, and “tag b” is given to each “well” of the sentence 23.

Here, the description returns to FIG. 6. In step S204, the training unit 205 performs training of the tag estimation model by using the augmented token strings with the augmented tags. Thereafter, the process of FIG. 6 ends.

As described above, in the embodiment, the augmented token strings are generated by looping the token string used for training of the tag estimation model so that the predetermined number of tokens are obtained. Furthermore, in the embodiment, the tags are appended to the augmented token strings by looping the tags in accordance with the augmented token strings. Since the tags appended to the augmented token strings are the same as the tags appended to the original token string, noise is less likely to occur. The performance and robustness of the tag estimation model can be improved by training of the tag estimation model using the augmented token strings to which such augmented tags are appended.

### Modification 1

Hereinafter, a modification of the embodiment will be described. In the embodiment, an augmented token string is generated by looping a token string. However, the method of generating the augmented token string is not limited to the method of looping the token string. For example, the augmented token string may be generated by randomly adding a predetermined number of tokens to the token string included in the document data. As with the looping, the original token may be masked (replaced with [MASK]) with an appropriate probability set in advance.

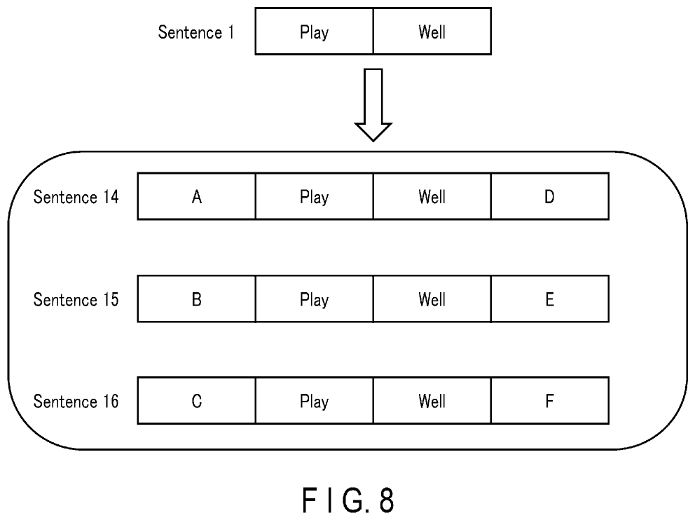

A method of generating an augmented token string according to the modification will be specifically described with reference to FIG. 8. FIG. 8 is a diagram illustrating a method of generating an augmented token string for the sentence 1, “play”, “well”. For example, the token number f(T_S) of the augmented token string is 4.

In the modification, the token string augmentation unit 103 generates an augmented token string by randomly adding tokens at the head and/or the tail of the input token string such that the number of tokens becomes f(T_S). For example, the token string augmentation unit 103 obtains a token group Ts to which a tag is not likely to be appended in the input document data. A token to which a tag is not likely to be appended in the case of sequential labeling is a token to which an “O” tag is appended, that is, a token that is not a unique expression.

Subsequently, the token string augmentation unit 103 randomly extracts tokens of which the number of tokens in the augmented token string is f(T_S) from the token group Ts, and adds the extracted tokens to the original token. For example, in a case where one token is appended to each of the head and the tail of the original token string, the string length of the token string is increased by two. An augmented token string of a specified string length can be generated by increasing the number of tokens to be appended.

For example, a sentence 14 is generated by giving “token A” and “token D” to the head and the tail of the token string of the sentence 1, respectively. Similarly, the sentence 15 is generated by giving “token B” and “token E” to the head and the tail of the token string of the sentence 1, respectively. Similarly, the sentence 16 is generated by giving “token C” and “token F” to the head and the tail of the token string of the sentence 1, respectively.

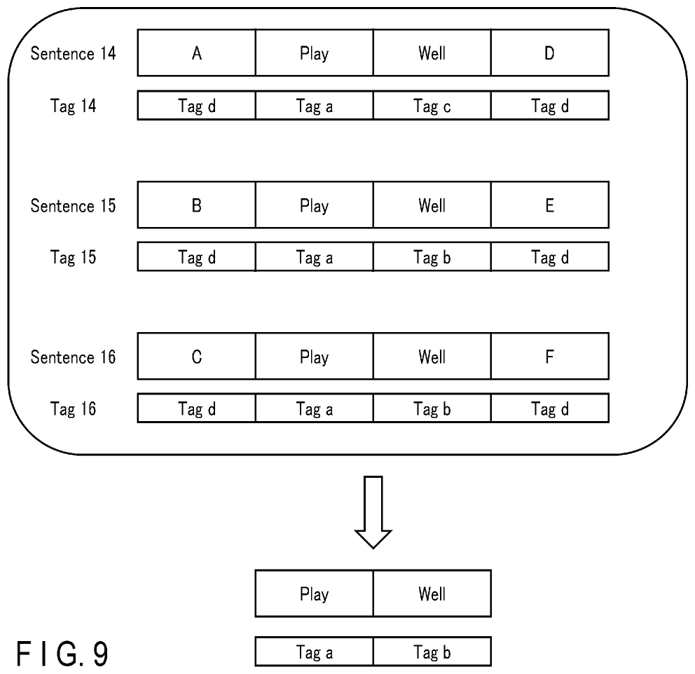

FIG. 9 is a diagram for describing voting in a modification. As a result of the estimation by the tag estimation model, it is assumed that tags indicated by a tag 14 should be appended to each token of the sentence 14, tags indicated by a tag 15 should be appended to each token of the sentence 15, and tags indicated by a tag 16 should be appended to each token of the sentence 16. Here, “tag d” is appended to each of “token A” and “token D” of the sentence 14, “token B” and “token E” of the sentence 15, and “token C” and “token F” of the sentence 16. The “tag d” is a tag of “O”.

The sentences 14 to 16 are simply generated by adding a token, but as described above, may be generated by masking the original token with an appropriate probability set in advance (replacing with [MASK]).

The voting unit 105 counts tags estimated for the original token. In the example of FIG. 9, for the original token “play”, three “tag a” are estimated as a tag to be appended. At this time, the voting unit 105 determines the “tag a” with the most votes as a tag for the original token “play”. Similarly, for the original token “well”, two “tag b” and one “tag c” are estimated as a tag to be appended. At this time, the voting unit 105 determines the “tag b” with the most votes as a tag for the original token “well”.

In the example of FIG. 9, the tag may be appended only when the ratio of the tag having the maximum number of votes for each token to the total number of votes exceeds a predetermined threshold. In addition, the weight of the vote may be changed for each tag.

In addition, in the augmentation of the tag at the time of training of the tag estimation model, a tag “O” maybe appended to the token added in the augmented token string.

In the modification described above, an augmented token strings are generated by randomly adding tokens to a token string so that the number of tokens becomes a predetermined number. Even in such a modification, the data augmentation of the token string can be performed by a simple method. In addition, the augmented token string generated in the modification also holds the information of the original token string as it is. Therefore, the augmented token string generated by the method of the modification is less likely to be noise. In addition, at the time of estimating the tag, the range of the tag to be finally appended is determined by voting on the result using the plurality of augmented token strings. Therefore, the estimation result of the tag is easily stabilized. As a result, the performance and robustness of the tag estimation model can be improved.

Furthermore, the randomly added token is a token to which no tag is appended. Therefore, decrease in training efficiency due to the tag being appended to the randomly appended token is suppressed.

### Modification 2

In the above-described embodiment, the tag estimation model is assumed to append a tag by the sequence labeling method. However, the tag estimation model does not necessarily append a tag by the sequence labeling method. For example, the tag estimation model may append a tag by the semantic segmentation method. In the case of semantic segmentation, the document data is treated as image data. Then, the tag estimation model appends a tag in units of pixels when document data is regarded as image data. In the sequence labeling, the range starting with B and followed by I is the range of a tag representing a unique expression. On the other hand, in the semantic segmentation, the obtained range directly becomes the range of a tag representing the unique expression.

### Modification 3

In the above-described embodiment, the tag finally appended is determined by voting on the output of the tag estimation model. This voting corresponds to processing in the output layer of the tag estimation model. On the other hand, voting may be performed in a hidden layer of the tag estimation model. In this case, the tag estimation model may determine a tag to be finally appended after obtaining an appropriate vector by averaging the augmented token strings for the same token.

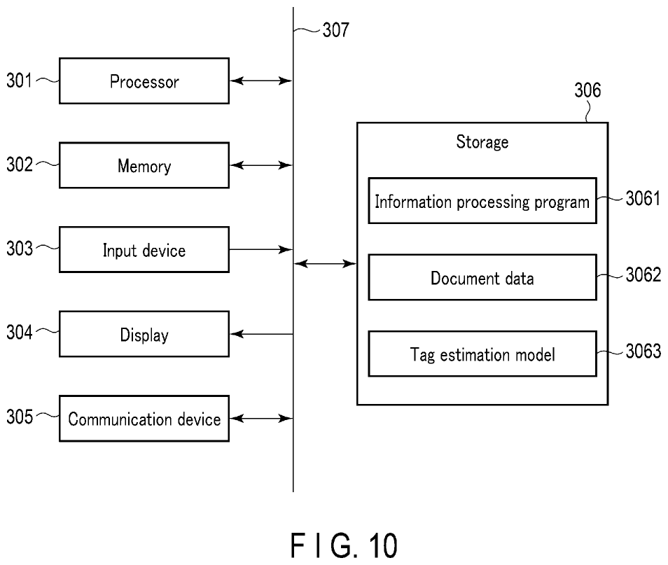

Hereinafter, an example of a hardware configuration of the information processing apparatus will be described. FIG. 10 is a diagram illustrating an example of a hardware configuration of the information processing apparatus. The information processing apparatus is a computer, and includes, for example, a processor 301, a memory 302, an input device 303, a display 304, a communication device 305, and a storage 306 as a hardware. The processor 301, the memory 302, the input device 303, the display 304, the communication device 305, and the storage 306 are connected to a bus 307.

The processor 301 is a processor that controls the overall operation of the information processing apparatus. The processor 301 can operate as the document acquisition unit 102, the token string augmentation unit 103, the estimation unit 104, the voting unit 105, and the output unit 106, for example, by executing a program stored in the storage 306. Furthermore, the processor 301 can operate as the document acquisition unit 202, the token string augmentation unit 203, the tag augmentation unit 204, and the training unit 205 by executing a program stored in the storage 306, for example. The processor 301 is, for example, a CPU. The processor 301 may be an MPU, a GPU, an ASIC, an FPGA, or the like. The processor 301 may be a single CPU or the like, or may be a plurality of CPUs or the like. As described above, the information processing apparatus that performs tagging and the information processing apparatus that performs training of the tag estimation model may be separate information processing apparatuses.

The memory 302 includes a ROM and a RAM. The ROM is a nonvolatile memory. The ROM stores a startup program and the like of the information processing apparatus. The RAM is a volatile memory. The RAM is used as a working memory at the time of processing in the processor 301, for example.

The input device 303 is an input device such as a touch panel, a keyboard, or a mouse. When the input device 303 is operated, a signal corresponding to the operation content is input to the processor 301 via the bus 307. The processor 301 performs various processes according to this signal.

The display 304 is a display such as a liquid crystal display or an organic EL display. Instead of or in addition to the display 304, an output device for various types of information such as a printer may be provided. Furthermore, the display 304 is not necessarily provided in the information processing apparatus, and may be an external display device capable of communicating with the information processing apparatus.

The communication device 305 is a communication device for the information processing apparatus to communicate with an external device. The communication device 305 may be a communication device for wired communication or a communication device for wireless communication.

The storage 306 is, for example, a storage such as a hard disk drive or a solid state drive. The storage 306 stores various programs executed by the processor 301, such as the information processing program 3061.

Furthermore, the storage 306 may operate as the document storage unit 101 or the document storage unit 201. In this case, the storage 306 stores the document data 3062. Further, the storage 306 may store a tag estimation model 3063. The document data 3062 and the tag estimation model 3063 maybe stored in a device different from the information processing apparatus. In this case, the information processing apparatus acquires necessary information by accessing another apparatus using the communication device 305.

The bus 307 is a data transfer path for exchanging data among the processor 301, the memory 302, the input device 303, the display 304, the communication device 305, and the storage 306.

The instructions described in the processing procedure illustrated in the above-described embodiment can be executed based on a program that is software. By storing this program in advance and reading this program, a general-purpose computer system can obtain an effect similar to the effect of the information processing apparatus described above. The instructions described in the above-described embodiments are recorded in a magnetic disk (flexible disk, hard disk, and the like), an optical disk (CD-ROM, CD-R, CD-RW, DVD-ROM, DVD±R, DVD±RW, Blu-ray (registered trademark) Disc, and the like), a semiconductor memory, or a recording medium similar thereto as a program that can be executed by a computer. The storage format may be any form as long as it is a recording medium readable by a computer or an embedded system. When the computer reads a program from the recording medium and causes the CPU to execute an instruction described in the program based on the program, the same operation as that of the information processing apparatus according to the above-described embodiment can be realized. Of course, when the computer acquires or reads the program, the program may be acquired or read through a network.

In addition, an operating system (OS) running on a computer, database management software, middleware (MW) such as a network, or the like based on instructions of a program installed from a recording medium to the computer or an embedded system may execute a part of each process for realizing the present embodiment.

Furthermore, the recording medium in the present embodiment is not limited to a medium independent of a computer or an embedded system, and includes a recording medium that downloads and stores or temporarily stores a program transmitted via a LAN, the Internet, or the like.

Furthermore, the number of recording media is not limited to one, and a case where the processing in the present embodiment is executed from a plurality of media is also included in the recording media in the present embodiment, and the configuration of the media may be any configuration.

Note that the computer or the embedded system in the present embodiment is for executing each processing in the present embodiment on the basis of a program stored in a recording medium, and may have any configuration such as a device including one of a personal computer, a microcomputer, and the like, a system in which a plurality of devices is connected to a network, and the like.

In addition, the computer in the present embodiment is not limited to a personal computer, and includes an arithmetic processing device, a microcomputer, and the like included in an information processing apparatus, and collectively refers to a device and a device capable of realizing a function in the present embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor including a hardware, configured to:
perform augmentation on a token string included in acquired document data so as to maintain an arrangement of an original token string to generate a plurality of augmented token strings;
estimate a tag to be appended to each of the augmented token strings; and
determine a tag to be appended to the token string based on the tag estimated for each of the augmented token strings.

2. The information processing apparatus according to claim 1, wherein the processor is configured to generate the augmented token strings by looping the token string with a shifted start position so as to obtain a predetermined number of tokens.

3. The information processing apparatus according to claim 1, wherein the processor is configured to generate the augmented token strings by looping a token string with a shifted start position a predetermined number of times.

4. The information processing apparatus according to claim 1, wherein the processor is configured to generate the augmented token strings by adding a predetermined number of random tokens to a head and/or a tail of the token string.

5. An information processing apparatus comprising a processor including a hardware, configured to:
perform augmentation on a token string included in acquired tagged document data so as to maintain an arrangement of an original token string to generate a plurality of augmented token strings;
perform augmentation on a tag appended to the token string; and
perform training of a tag estimation model for estimating a tag appended to each of the augmented token strings by using the augmented token strings to which an augmented tag is appended.

6. The information processing apparatus according to claim 5, wherein the processor is configured to generate the augmented token strings by looping the token string with a shifted start position so as to obtain a predetermined number of tokens.

7. The information processing apparatus according to claim 5, wherein the processor is configured to generate the augmented token strings by looping a token string with a shifted start position a predetermined number of times.

8. The information processing apparatus according to claim 5, wherein the processor is configured to generate the augmented token strings by adding a predetermined number of random tokens to a head and/or a tail of the token string.

9. The information processing apparatus according to claim 5, wherein the tag estimation model is a model that estimates a tag using a sequence labeling method.

10. The information processing apparatus according to claim 5, wherein the tag estimation model is a model that estimates a tag using a semantic segmentation method.

11. An information processing method comprising:
performing augmentation on a token string included in acquired document data so as to maintain an arrangement of an original token string to generate a plurality of augmented token strings;
estimating a tag to be appended to each augmented token string; and
determining a tag to be appended to the token string based on the tag estimated for each augmented token string.

12. An information processing method comprising:
performing augmentation on a token string included in acquired tagged document data so as to maintain an arrangement of an original token string to generate a plurality of augmented token strings;
performing augmentation on a tag appended to the token string; and
perform training of a tag estimation model for estimating a tag appended to each of the augmented token strings by using the augmented token strings to which an augmented tag is appended.

13. A non-transitory computer-readable storage medium storing an information processing program for causing a computer to execute:
performing augmentation on a token string included in acquired document data so as to maintain an arrangement of an original token string to generate a plurality of augmented token strings;
estimating a tag to be appended to each augmented token string; and
determining a tag to be appended to the token string based on the tag estimated for each augmented token string.

14. A non-transitory computer-readable storage medium storing an information processing program for causing a computer to execute:
performing augmentation on a token string included in acquired tagged document data so as to maintain an arrangement of an original token string to generate a plurality of augmented token strings;
performing augmentation on a tag appended to the token string; and
perform training of a tag estimation model for estimating a tag appended to each of the augmented token strings by using the augmented token strings to which an augmented tag is appended.
